(19) United States
(12) Patent Application Publication
(10) Pub. No.: US 2020/0372183 A1
(43) Pub. Date: Nov. 26, 2020

(54) Digitally Signing Software Packages With Hash Values

(71) Applicant: Hewlett Packard Enterprise Development LP, Houston, TX (US)

(72) Inventors: Sumitha Rangaiah, Bangalore (IN); Preetham Veeranna, Bangalore (IN); Sathish Kumar Chandru, Bangalore (IN); Sandya Bhoajaraj, San Jose, CA (US)

(21) Appl. No.: 16/418,094

(22) Filed: May 21, 2019

(51) Int. Cl. G06F 21/64; G06F 21/16; G06F 21/56; G06F 21/12; H04L 9/32

(52) U.S. Cl. CPC G06F 21/64; G06F 21/16; H04L 9/3247; G06F 21/125; H04L 9/3239; G06F 21/565

(57) ABSTRACT

In one implementation, a non-transitory machine-readable storage medium may store instructions that upon execution cause a processor to: receive a program file and a first hash from a client device, where the first hash is generated by the client device based on the program file; in response to a determination that the program file does not include malicious content, generate a second hash based on the program file; in response to a determination that the generated second hash matches the received first hash, sign the generated second hash; and provide the signed second hash to the client device.

### BACKGROUND

Software development may include various stages between the conception of the software through to the final production of the software. For example, a software development process may include product specification, design, programming, documentation, testing, and so forth. Once completed, the software may be digitally signed to establish the source of the software, and to confirm that the software has not been altered since being signed.

### BRIEF DESCRIPTION OF THE DRAWINGS

Some implementations are described with respect to the following figures.

FIG. 1 is a schematic diagram of an example system, in accordance with some implementations.

FIGS. 2A-2B are illustrations of example processes, in accordance with some implementations.

FIGS. 3A-3C are illustrations of example program files, in accordance with some implementations.

FIG. 4 is an illustration of an example process, in accordance with some implementations.

FIG. 5 is a schematic diagram of an example computing device, in accordance with some implementations

FIG. 6 is a diagram of an example machine-readable medium storing instructions in accordance with some implementations.

### DETAILED DESCRIPTION

A digital signature may be applied to a software application. The signature may be used to authenticate the content of the application. In some examples, the digital signature may be provided by an external service that is remote from the developer of the application. In such examples, the signing process may involve transferring a program file from the developer to the external service, waiting for the external service to complete the signing of the program file, and transferring the signed program file back to the developer. This signing process may require a large amount of time to complete, and may thus increase the development cost of the application. Further, because the program file is exposed over a network, there may be a risk that malicious content is inserted into the file prior to being signed. As used herein, a “program file” may refer to an individual document or a package of multiple documents. For example, a program file may be a package aggregating multiple class files, associated metadata, and resources (e.g., a Java archive (JAR) file). In some examples, a header portion of the program file may include metadata regarding the program file. Further, in some examples, the header portion of a program file may include a manifest file listing a software version, information about multiple files included in the program file, and so forth.

In some examples, the external service may sign a hash of a header portion of the program file, instead of signing the entire program file. For example, a client device may apply a hash function to a manifest file of a Java archive (JAR) file, thereby generating a hash value associated with the JAR file. The client may transfer the hash value and the JAR file to an external service. The external service may determine that the JAR file does not include malicious content, and in response may generate a hash value of the manifest file of the JAR file. If the hash value generated by the external service matches the hash value provided by the client device, the external service may sign the hash value, and may send the signed hash value back to the client device. However, in some examples, the manifest file may specify the Java software version of the computing device including the JAR file. Accordingly, if the client device and the external service are using different Java versions, the two hash values will not match. In this event, the external service will not sign the hash value, and thus the signing process will fail.

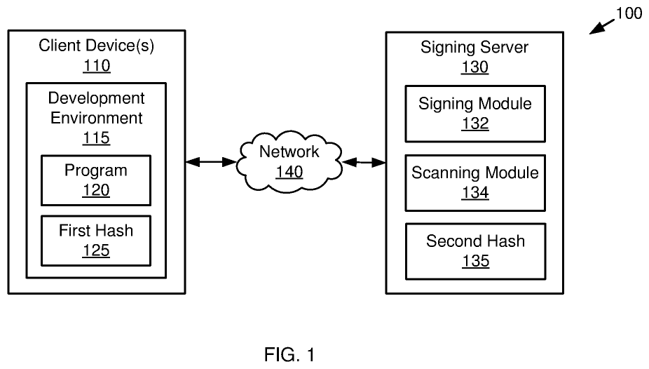

As described further below with reference to FIGS. 1-6, some implementations may provide digitally signing of program files. As used herein, a “program file” may refer to an individual document or a package of multiple documents. For example, a program file may be a package aggregating multiple class files, associated metadata, and resources (e.g., a program archive file such as a Java archive (JAR) file). In some implementations, a client device may generate a first hash based on a modified version of all or a portion of a program file, and may provide the first hash and the original program file to a signing server. For example, the first hash may be generated from a modified version of a header portion of the program file, where the modified version replaces a software version number with a fixed string. The signing server may determine whether the program file includes malicious content. If the program file does not include malicious content, the signing server may generate a second hash based on the modified version of the header portion of the program file, and may determine whether the second hash matches the first hash. If the two hashes match, the signing server may sign the hash value, and provide the signed hash to the client device. The client device may embed the signed hash in the program file. In this manner, the time associated with signing the program file and the risk of inserted malicious content may be reduced. Further, header information that may vary across devices may be replaced by a fixed string, and thus the two hash values will match even the two devices are associated with different header information. For example, the disclosed hash signing process may avoid errors due to mismatches in software version numbers in a header portion of a program archive file. Accordingly, hash matching errors due to different header information may be reduced or eliminated.

FIG. 1 is a schematic diagram of an example system 100, in accordance with some implementations. As shown, the system 100 may include one or more client devices 110 connected to a signing server 130 via a communication network 140. Each client device 110 may be a computing device such a desktop computer, a portable device, a communication device, an appliance, and so forth. The client device 110 may include development environment 115. Although not shown in FIG. 1 for the sake of simplicity, the client device 110 and/or signing server 130 may include hardware components such as a processor, memory, a storage device, a display device, and so forth. The signing server 130 may be a standalone server, a blade server, a computing cluster, a virtual server, a web service, and the like. As shown, the signing server 130 may include a signing module 132 and a scanning module 134. As used herein, “module” may refer to hardware and/or software logic (e.g., stored instructions executed by a processor, a digital circuit, a specialized controller, etc.).

In some implementations, the development environment 115 may provide functionality to allow a user to create and/or modify a software program 120. A digital copy of the program 120 may be stored in the client device 110. In some examples, the program 120 may be a program archive file (e.g., a Java archive (JAR) file). As used herein, a “program archive file” is an application package including various program files (e.g., class files, resources, etc.), where at least one data element of the application package is based on characteristics of a device storing the program archive file. For example, the program 120 may be a Java archive (JAR) file including a manifest file that specifies a Java Development Kit version installed in the computing device storing the JAR file.

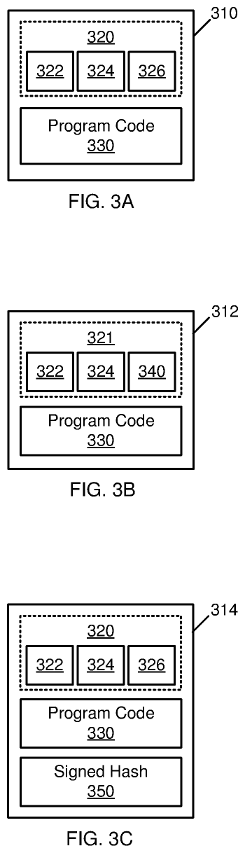

In some implementations, the development environment 115 may also provide functionality to allow the user to request (e.g., via a command to the development environment 115) that the program 120 be digital signed. In response to this request, the development environment 115 may generate the first hash 125 based on the program 120, and may transmit the program 120 and the first hash 125 to the signing server 130. In some examples, the first hash 125 may be a value generated by applying a hash function to a modified version of all or a portion of the program 120. In some examples, the hash function may transform a variable length input string into a fixed-length digest of smaller size. The hash function may involve iterative calculations such as bitwise logical word operations, modulo addition, bit shift operations, bit rotate operations (e.g., circular shift), and/or combinations thereof. In some implementations, the first hash 125 may be generated using one or more cryptographic hashing algorithms such as Message Digest 5 (MD5), Secure Hashing Algorithm 256 (SHA-256), SHA-512, SHA3-224, and so forth. The generation of the first hash 125 is described further below with reference to FIGS. 3A-3C.

In some implementations, the scanning module 134 of the signing server 130 may scan the program 120 for any malicious content (e.g., spyware, viruses, worms, and so forth). For example, the scanning module 134 may search for signatures of known malicious content (e.g., a string of text characters, binary computer code, a numeric network address, a suspicious program action, and so forth). In some examples, such signatures may be obtained from organizations that specialize in computer security.

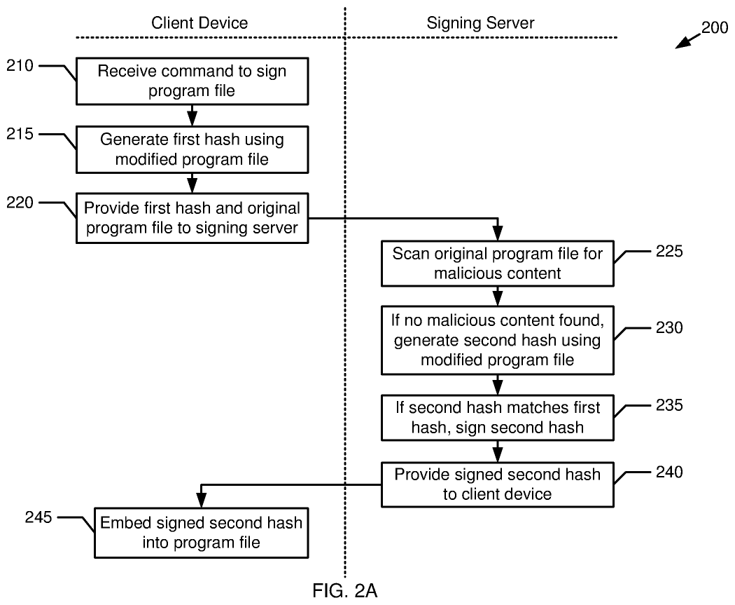

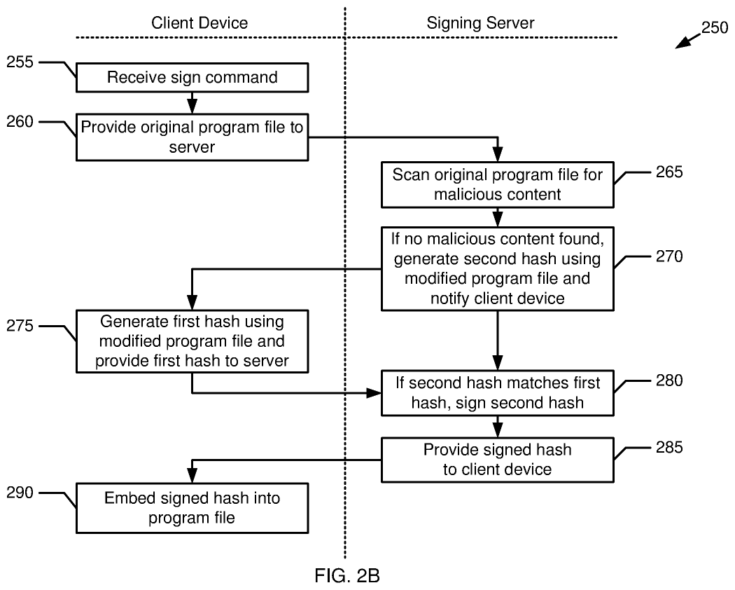

If the scanning module 134 determines that the program 120 does not include malicious content, the signing module 132 may generate a second hash 135 based on the program 120, and may compare the second hash 135 to the first hash 125 received from the client device 110. In some examples, the second hash 135 may be a value generated by applying a hash function to a modified version of all or a portion of the program 120. If the two hash values 125, 135 are equal, the signing module 132 may sign the first hash 125 or the second hash 135, and may provide the signed hash to the client device 110. As used herein, “signing” the hash refers to encrypting the hash using a public key algorithm (e.g., the Rivest-Shamir-Adleman (RSA) algorithm). In some implementations, the keys used by the signing module 132 to sign the hash may be obtained from a secure vault (e.g., a hardware security module (HSM) that security stores private keys). The client device may use the signed hash to sign the program 120. Various aspects of program signing are discussed further below with reference to FIGS. 2-8.

In some implementations, the modified version of all or a portion of the program 120 used to generate hash values comprises a modified version of a header portion of the program 120 (e.g., a manifest file of a JAR file). In some examples, the modified version replaces a header field with a defined string. For example, the header field may be a software version number (e.g., a Java Development Kit version number), and the defined string may be a dummy software version number. Assume that, in some examples, the client device 110 and the signing server 130 may be associated with different software version numbers. Assume further that a hash of the original program 120 (or a header portion thereof) will reflect the software version number of the device generating the hash. Accordingly, in some examples, a hash of the original program 120 that is generated by the client device 110 will differ from a hash of the original program 120 that is generated by the signing server 130. As such, comparing hashes of the original program 120 may result in matching errors due to different header information (e.g., different software version numbers of different devices).

Referring now to FIG. 2A, shown is an example process 200 in accordance with some implementations. Note that the process 200 is illustrated in FIG. 2A as being divided into two portions, namely a set of actions performed by a client device (e.g., client device 110 shown in FIG. 1) in the left portion of FIG. 2A, and a set of actions performed by a signing server (e.g., host signing server 130 shown in FIG. 1) in the right portion of FIG. 2A. However, implementations are not limited by FIG. 2A, and other examples are also possible. The process 200 may be implemented in hardware and/or machine-readable instructions (e.g., software and/or firmware). The machine-readable instructions are stored in a non-transitory computer readable medium, such as an optical, semiconductor, or magnetic storage device. For the sake of illustration, details of the process 200 may be described below with reference to FIGS. 1 and 3A-3C, which show examples in accordance with some implementations. However, other implementations are also possible.

Block 210 may include the client device receiving a command to sign a program file. For example, referring to FIG. 1, a user of the development environment 115 may enter a command to request the signing of the program 120. The user may be a programmer, developer, and so forth. In some examples, the program file may be a Java archive (JAR).

Block 215 may include the client device generating a first hash using a modified program file. For example, referring to FIG. 1, the development environment 115 may apply a hash function to a modified version of all or a portion of the program 120 to generate the first hash 125. For example, referring to FIG. 3A, shown is an original program file 310 that includes a header 320 and program code 330. In the example illustrated in FIG. 3A, the header 320 is shown to include various portions 322, 324, 326, which may represent header or metadata fields for the program file 310. In some implementations, the program file 310 may be modified by replacing one or more portions of the header 320 with a defined alphanumeric string. For example, referring to FIG. 3B, shown is a modified program file 312 with a modified header 321, in which header portion 326 (shown in FIG. 3A) has been replaced with a dummy string 340. In some examples, the header portion 326 that is replaced by string 340 is a programming language version number (e.g., a Java version number included in a JAR manifest file). In some examples, the string 340 may be a hard-coded version number (e.g., version 1.0), may be a version number agreed to by agreement between the client device and the signing server, and so forth. Referring now to FIGS. 1 and 3, the development environment 115 may apply a hash function to the modified header 321 (or all of the modified program file 312) to generate a first hash value (e.g., first hash 125 shown in FIG. 1). In some examples, the hash function applied to the first hash 125 may include one or more cryptographic hashing algorithms such as Message Digest 5 (MD5), Secure Hashing Algorithm 256 (SHA-256), SHA-512, SHA3-224, and so forth.

Block 220 of FIG. 2A may include the client device providing the first hash and the original program file to the signing server. For example, referring to FIG. 1, the development environment 115 of client device 110 may send the program 120 and the first hash 125 to the signing server 130 via the network 140. In some examples, the program 120 and the first hash 125 may be sent together to the signing server 130. In other examples, the program 120 and the first hash 125 may be sent to the signing server 130 at different times.

Block 225 may include the signing server scanning the original program file for malicious content. For example, referring to FIG. 1, the scanning module 134 of signing server 130 may scan the original program 120 for signatures of known malicious content (e.g., viruses, spyware, and so forth).

Block 230 may include the signing server generating a second hash using the modified program file if no malicious content is found by the scan. For example, referring to FIG. 1, the signing module 132 may determine that the original version of program 120 does not include malicious content, and in response may apply a hash function to a modified version of all or a portion of the received program 120 to generate the second hash 135. In some implementations, the second hash 135 is generated using the same modified version of program file 120 and hashing function that were used to generate the first hash 125 (i.e., at block 215). For example, the development environment 115 may use a defined string in place of a particular header field to generate the first hash 125 (at block 220), and the signing module 132 may use the same defined string in place of the same particular header field to generate the second hash 135 (at block 250). In some examples, the defined string used in the modified version of program file 120 may be a hard-coded version number (e.g., version 1.0), may be a version number agreed to by agreement between the client device and the signing server, and so forth. In some implementations, if the scan detects malicious content in the original version of program 120, an exception and/or warning may be raised, and the process 200 may be terminated.

Block 235 may include the signing server signing the second hash if the second hash matches the first hash. Block 240 may include the signing server providing the signed second hash to the client device. For example, referring to FIG. 1, the signing module 132 may determine that the second hash 135 is identical to the first hash 125 (received from the client device 110), and in response may sign the hash value (i.e., the same value of first hash 125 and second hash 135). In some examples, the signing module 132 may encrypt the hash value using a public key algorithm (e.g., the RSA algorithm). In some implementations, the keys used by the signing module 132 to sign the hash value may be obtained from a secure vault (e.g., a hardware security module). The signing module 132 may then send the signed hash value to the development environment 115 of the client device 110. In some implementations, if the second hash does not match the first hash, an exception and/or warning may be raised, and the process 200 may be terminated.

Block 245 may include the client device embedding the signed second hash into the original program file. For example, referring to FIG. 1, the development environment 115 may embed the encrypted hash value (provided by signing server 130) into the program file 120. Referring now to FIG. 3C, shown is a signed program file 314 that includes the header 320, program code 330, and a signed hash 350. Note that the header 320 of the signed program file 314 includes the header portion 326 (from original program file 310 shown in FIG. 3A) rather than the string 340 (from modified program file 312 shown in FIG. 3B). After block 245, the process 200 may be completed. In some implementations, the signed program file 314 may also include data regarding the hashing algorithm used to sign the hash, decryption information for decrypting the signed hash, and so forth.

Referring now to FIG. 2B, shown is an example process 250 in accordance with some implementations. The process 250 may be implemented in hardware and/or machine-readable instructions (e.g., software and/or firmware). The machine-readable instructions are stored in a non-transitory computer readable medium, such as an optical, semiconductor, or magnetic storage device. For the sake of illustration, details of the process 250 may be described below with reference to FIGS. 1 and 3A-3C, which show examples in accordance with some implementations. However, other implementations are also possible.

Block 255 may include the client device receiving a command to sign a program file. For example, referring to FIG. 1, a user of the development environment 115 may enter a command to request the signing of the program 120.

Block 260 may include the client device providing the original program file to the signing server. For example, referring to FIG. 1, the development environment 115 of client device 110 may send the program 120 to the signing server 130 via the network 140.

Block 265 may include the signing server scanning the original program file for malicious content. For example, referring to FIG. 1, the scanning module 134 of signing server 130 may scan the original program 120 for signatures of known malicious content.

Block 270 may include the signing server, if no malicious content is found by the scan, generating a second hash using the modified program file and notifying the client device that no malicious content was detected by the scan. For example, referring to FIG. 1, the signing module 132 may determine that the original version of program 120 does not include malicious content, and in response may apply a hash function to a modified version of all or a portion of the received program 120 to generate the second hash 135. Further, the signing module 132 may notify the client device 110 that no malicious content was found by a scan performed by the scanning module 134. In some implementations, the second hash 135 is generated by applying a hashing function to a modified header of program 120. In some implementations, if the scan detects malicious content in the original version of program 120, an exception and/or warning may be raised, and the process 250 may be terminated.

Block 275 may include the client device generating a first hash using a modified program file and providing the first hash to the signing server. For example, referring to FIG. 1, the development environment 115 may apply a hash function to a modified version of all or a portion of the program 120 to generate the first hash 125. In some examples, the first hash 125 may be generated using the same modified version of program file 120 and hashing function that were used to generate the second hash 135 (i.e., at block 270).

Block 280 may include the signing server signing the second hash if the second hash matches the first hash. Block 285 may include the signing server providing the signed second hash to the client device. For example, referring to FIG. 1, the signing module 132 may determine that the second hash 135 is identical to the first hash 125 (received from the client device 110), and in response may sign the hash value (i.e., the same value of first hash 125 and second hash 135). In some implementations, if the second hash does not match the first hash, an exception and/or warning may be raised, and the process 250 may be terminated.

Block 290 may include the client device embedding the signed hash into the original program file. For example, referring to FIG. 1, the development environment 115 may embed the encrypted hash value (provided by signing server 130) into the program file 120. After block 290, the process 250 may be completed.

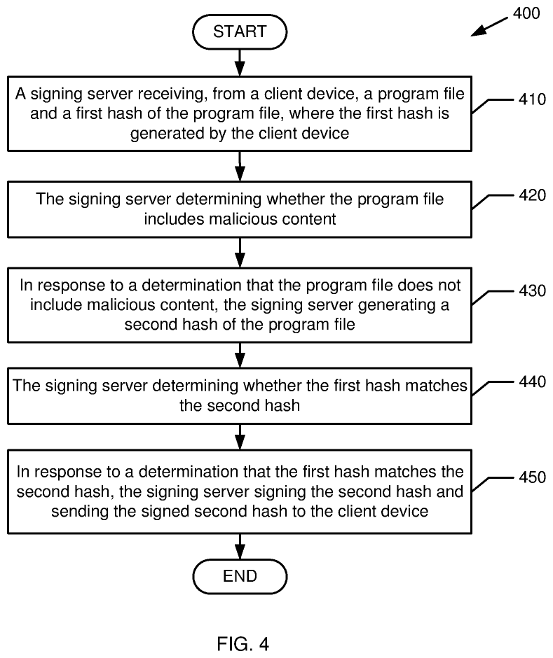

Referring now to FIG. 4, shown is an example process 400, in accordance with some implementations. The process 400 may performed by the system 100 (shown in FIG. 1). However, implementations are not limited by FIG. 4, and other examples are also possible. The process 400 may be implemented in hardware and/or machine-readable instructions (e.g., software and/or firmware). The machine-readable instructions are stored in a non-transitory computer readable medium, such as an optical, semiconductor, or magnetic storage device. For the sake of illustration, details of the process 400 may be described below with reference to FIGS. 1-3C, which show examples in accordance with some implementations. However, other implementations are also possible.

Block 410 may include a signing server receiving, from a client device, a program file and a first hash based on the program file, where the first hash is generated by the client device. For example, referring to FIG. 1, the client device 110 may apply a hash function to a modified version of the program 120 to generate the first hash 125. In some examples, the modified version of the program 120 may have a header portion that is replaced by a fixed dummy string. For example, the modified version of the program 120 may be a program archive file (e.g., a JAR file) including a manifest file that specifies a dummy software version number (e.g., a fixed JDK version number). The client device 110 may transmit the first hash 125 and the original version of the program 120 to the signing server 130. In some examples, the program 120 and the first hash 125 may be sent together to the signing server 130. In other examples, the program 120 may be sent to the signing server 130 at an earlier time, and the first hash 125 may be sent to the signing server 130 at a later time (e.g., in response to a notification from the signing server 130).

Block 420 may include the signing server determining whether the program file includes malicious content. For example, referring to FIG. 1, the scanning module 134 of signing server 130 may scan the original version of program 120 for signatures of known malicious content (e.g., viruses, spyware, etc.).

Block 430 may include, in response to a determination that the program file does not include malicious content, the signing server generating a second hash based on the program file. For example, referring to FIG. 1, the signing module 132 may determine that the original version of program 120 does not include malicious content, and in response may apply a hash function to a modified version of program 120 to generate the second hash 135. In some examples, the second hash 135 is generated using the same hashing function and modified version of program 120 that were used to generate the first hash 125 (received at block 410). In some implementations, the defined string included in the modified version of program file 120 may be a hard-coded version number (e.g., version 1.0), may be a version number agreed to by agreement between the client device and the signing server, and so forth.

Block 440 may include the signing server determining whether the first hash matches the second hash. Block 450 may include, in response to a determination that the first hash matches the second hash, the signing server signing the second hash and sending the signed second hash to the client device. For example, referring to FIG. 1, the signing module 132 may determine that the second hash 135 is identical to the first hash 125, and in response may encrypt the hash value using a public key algorithm (e.g., a RSA algorithm). The signing module 132 may then send the signed hash value to the client device 110. In some implementations, the client device 110 may embed the signed second hash into the original program file 120. After block 450, the process 400 may be completed.

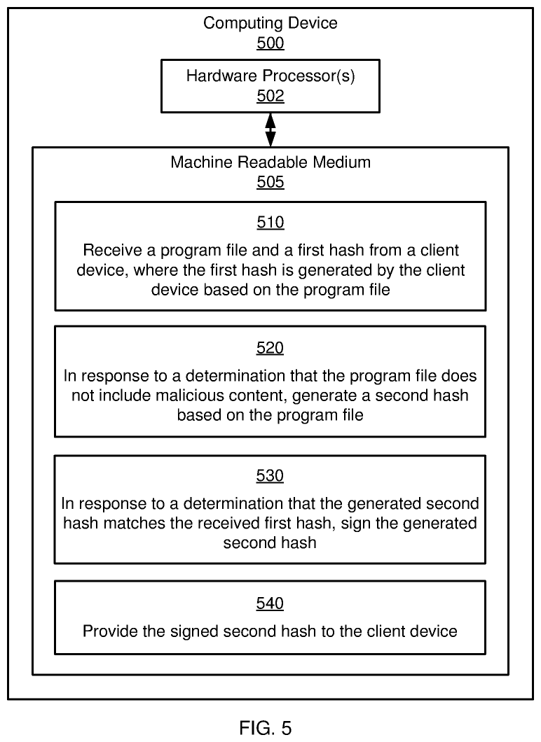

Referring now to FIG. 5, shown is a schematic diagram of an example computing device 500. In some examples, the computing device 500 may correspond generally to the signing server 130 (shown in FIG. 1). As shown, the computing device 500 may include hardware processor(s) 502 and machine-readable storage medium 505 including instructions 510-540. The machine-readable storage medium 505 may be a non-transitory medium. The instructions 510-540 may be executable by the hardware processor(s) 502. The hardware processor(s) 502 may include a general purpose microprocessor, a specialized controller, a processor module or subsystem, a programmable integrated circuit, a programmable gate array, multiple processors, a microprocessor including multiple processing cores, and so forth.

Instruction 510 may be executed to receive a program file and a first hash from a client device, where the first hash is generated by the client device based on the program file. Instruction 520 may be executed to, in response to a determination that the program file does not include malicious content, generate a second hash based on the program file. Instruction 530 may be executed to, in response to a determination that the generated second hash matches the received first hash, sign the generated second hash. Instruction 540 may be executed to provide the signed second hash to the client device.

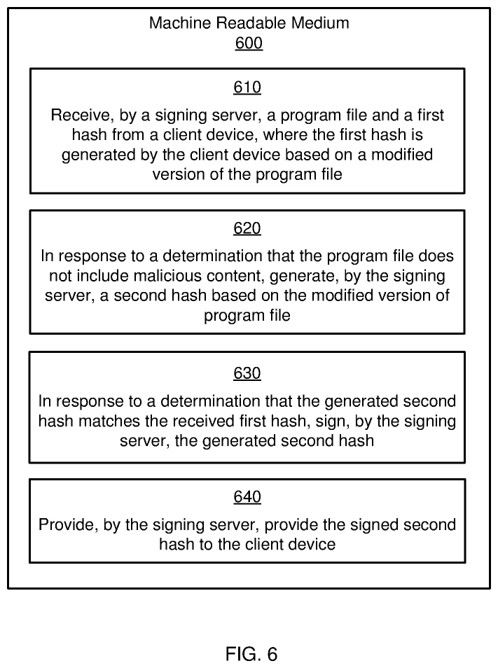

Referring now to FIG. 6, shown is machine-readable medium 800 storing instructions 610-640, in accordance with some implementations. The instructions 610-640 can be executed by one or more hardware processors. The machine-readable medium 600 may be a non-transitory storage medium, such as an optical, semiconductor, or magnetic storage medium.

Instruction 610 may be executed to receive, by a signing server, a program file and a first hash from a client device, where the first hash is generated by the client device based on a modified version of the program file. Instruction 620 may be executed to, in response to a determination that the program file does not include malicious content, generate, by the signing server, a second hash based on the modified version of the program file. Instruction 630 may be executed to in response to a determination that the generated second hash matches the received first hash, sign, by the signing server, the generated second hash. Instruction 640 may be executed to provide, by the signing server, provide the signed second hash to the client device.

Note that, while FIGS. 1-6 show various examples, implementations are not limited in this regard. For example, referring to FIG. 1, it is contemplated that system 100 may include additional devices, different devices, different components, different connection paths, different protocols, and so forth. In another example, it is contemplated that a client device 110 and/or the signing server 130 may include other software components and/or hardware components (e.g., processors, memory, storage devices, etc.). In still another example, while not shown in each of FIG. 1-6, the devices described above may include additional components, such as memory (e.g., dynamic random access memory (DRAM)), processors, controllers, storage devices, buses, switches, batteries, antennas, display devices, input devices, power supplies, and so forth. Other combinations and/or variations are also possible.

In accordance with some implementations, examples may provide improved digitally signing of program files. Specifically, a client device and a signing server may generate respective hash values based on a modified version of a program file. The signing server may determine that the program file does not include malicious content. Further, the signing server may determine whether the two hash values match, and if so may sign the hash value. The client device may embed the signed hash in the program file. In this manner, the time associated with signing the program file and the risk of inserted malicious content may be reduced. Further, header information that may vary across devices may be replaced by a fixed string, and thus the two hash values will match even if the two devices are associated with different header information. Accordingly, hash matching errors due to different header information may be reduced or eliminated.

Data and instructions are stored in respective storage devices, which are implemented as one or multiple computer-readable or machine-readable storage media. The storage media include different forms of non-transitory memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A computing device comprising:
a processor; and
a storage medium including instructions executable by the processor to:
receive a program file and a first hash from a client device, wherein the first hash is generated by the client device based on the program file;
in response to a determination that the program file does not include malicious content, generate a second hash based on the program file;
in response to a determination that the generated second hash matches the received first hash, sign the generated second hash; and
provide the signed second hash to the client device.

2. The computing device of claim 1, the instructions executable by the processor to:
apply a hash function to a modified header of the program file to generate the second hash, wherein the modified header of the program file includes a defined string in place of a header field in an original header of the program file.

3. The computing device of claim 2, wherein the first hash is generated by the client device by applying the hash function to the modified header of the program file.

4. The computing device of claim 2, wherein the header field is a software version number, and wherein the defined string is a dummy software version number.

5. The computing device of claim 5, wherein the client device and the signing server are associated with different software version numbers.

6. The computing device of claim 1, the instructions executable by the processor to:
perform a scan of an original version of the program file, the scan to identify malicious content, wherein the received program file is the original version of the program file.

7. The computing device of claim 1, wherein the program file is a program archive file, wherein the client device is to embed the signed second hash into the program archive file.

8. A non-transitory machine-readable storage medium storing instructions that upon execution cause a processor to:
receive, by a signing server, a program file and a first hash from a client device, wherein the first hash is generated by the client device based on a modified version of the program file;
in response to a determination that the program file does not include malicious content, generate, by the signing server, a second hash based on the program file;
in response to a determination that the generated second hash matches the received first hash, sign, by the signing server, the generated second hash; and
provide, by the signing server, provide the signed second hash to the client device.

9. The non-transitory machine-readable storage medium of claim 8, wherein the modified version of the program file includes a defined string in place of a header field in an original version of the program file.

10. The non-transitory machine-readable storage medium of claim 9, wherein the header field is a software version number, and wherein the defined string is a dummy software version number.

11. The non-transitory machine-readable storage medium of claim 10, wherein the client device and the signing server are associated with different software version numbers.

12. The non-transitory machine-readable storage medium of claim 8, wherein the first hash is generated by the client device by applying a first hash function to the modified version of the program file, and wherein the second hash is generated by the signing server by applying the first hash function to the modified version of the program file.

13. The non-transitory machine-readable storage medium of claim 8, wherein the instructions cause the processor to:
perform a scan of an original version of the program file, the scan to identify malicious content, wherein the received program file is the original version of the program file.

14. A method, comprising:
a signing server receiving, from a client device, a program file and a first hash based on the program file, wherein the first hash is generated by the client device;
the signing server determining whether the program file includes malicious content;
in response to a determination that the program file does not include malicious content, the signing server generating a second hash based on the program file;
the signing server determining whether the first hash matches the second hash; and
in response to a determination that the first hash matches the second hash, the signing server signing the second hash and sending the signed second hash to the client device.

15. The method of claim 14, further comprising:
applying, by the client device, a hash function to a modified header of the program file to generate the first hash.

16. The method of claim 15, further comprising:
applying, by the signing server, the hash function to the modified header of the program file to generate the second hash.

17. The method of claim 15, wherein the modified header of the program file includes a defined string in place of a header field in an original header of the program file.

18. The method of claim 17, wherein the header field is a software version number, and wherein the defined string is a dummy software version number.

19. The method of claim 17, further comprising:
performing, by the signing server, a scan of the original header of the program file to determine whether the program file includes malicious content.

20. The method of claim 14, further comprising:
embedding, by the client device, the signed second hash in the original program file.
